(19) United States
(12) Patent Application Publication
(10) Pub. No.: US 2021/0402495 A1
(43) Pub. Date: Dec. 30, 2021

(54) METHOD FOR MANUFACTURING OF GEARS

(71) Applicant: Klingelnberg AG, Zurich (CH)

(72) Inventors: Karl-Martin RIBBECK, Remscheid (DE); Jürgen WEBER, Hückeswagen (DE)

(21) Appl. No.: 17/358,595

(22) Filed: Jun. 25, 2021

(30) Foreign Application Priority Data
Jun. 26, 2020 (DE) 10 2020 116 893.4

(51) Int. Cl. B23F 23/10; B23F 9/10; B23F 23/00

(52) U.S. Cl. CPC B23F 23/10; B23F 23/006; B23F 9/10

(57) ABSTRACT

A method for producing gears, includes the following: machining of gears with a gear tool in a single-indexing method, wherein the gear tool produces tooth gaps on each of the gears by machining. A pitch compensation with compensation parameters is predefined for the gears; wherein the compensation parameters are predefined by a machine control as a function of a wear condition of the gear tool.

### CROSS-REFERENCE TO RELATED APPLICATIONS

This application claims priority to German Patent Application No. 10 2020 116 893.4, filed on Jun. 26, 2020, the contents of which are hereby incorporated by reference in their entirety.

### TECHNICAL FIELD

The subject matter of the disclosure is a method for manufacturing gears, comprising the method steps: machining of a plurality of gears with a gear tool in a single-indexing method, wherein the gear tool produces a plurality of tooth gaps on each gear of the plurality of gears by machining and wherein a pitch compensation with compensation parameters is predefined for the plurality of gears.

### BACKGROUND

In the context of bevel gear manufacturing, a distinction is made between the continuous indexing method and the single-indexing method.

The continuous indexing method is characterized in that the gear to be machined performs a continuous indexing movement during machining. This continuous indexing movement is coupled with the rotation of a gear tool causing chip removal in such a way that the gear tool makes individual cuts at successive tooth gaps on the gear to be machined. The gear to be machined therefore rotates continuously and repeatedly about its own axis during continuous chip removal until the gear tool has produced the full tooth depth on the gear. The gear tool is therefore continuously in chip-removing cutting contact with the gear to be machined.

In contrast to the continuous indexing method, in the single-indexing method the gear tool is always first used to completely produce a tooth gap, the gear is then turned by one tooth pitch, and then the next tooth gap is milled in the same way until all spaces have been produced. In the single-indexing method, the tooth gaps of the gear are therefore machined one after the other in a gear or gear blank to be machined. In other words, a first tooth gap of the gear is first completed by infeed and subsequent retraction of the gear tool with respect to the gear blank, before the gear blank is rotated by one tooth pitch and then a second tooth gap is completed by infeed and subsequent retraction of the gear tool with respect to the gear blank. The gear tool is therefore not in a continuous machining contact but is repeatedly fed in tooth gap by tooth gap.

In both the single-indexing method and the continuous indexing method, spiral bevel gears can be manufactured in a rolling, i.e. a generating process, or plunging, i.e. a non-generating process.

In the generating method, the tooth gaps of the pinion and ring gear of a bevel gear pair are each produced in generating processes, whereas in the so-called forming or plunging process, the tooth gaps of the ring gear are only produced by a plunging process of the rotating gear tool into the non-rolling workpiece, whereas the pinion tooth gaps are produced in a special generating process with the gear tool inclined to the generating axis. While in the plunging process the shape of the gear tool is transferred to the tooth flanks, in the generating process, in which the gear tool and workpiece move relative to each other according to a certain regularity, the tooth flanks are formed by enveloping cuts of the individual gear tool cutting edges.

Bevel gears can therefore be produced in a single-indexing method in a rolling or plunging manner or in a continuous indexing method in a rolling or plunging manner.

In the single-indexing method, the machined gear heats up to 50° C., particularly during dry milling, i.e. soft gear cutting without cooling lubricant. Starting from a room temperature of 20° C., for example, the gear therefore heats up by up to 30° C. during machining due to the cutting contact with the gear tool. This heating causes pitch deviations because the gear expands due to the heat input. The pitch or circular pitch defines the distance between two adjacent left flanks or right flanks of the teeth of a gear. In simplified terms, the pitch deviation therefore describes whether a tooth of the gear is in the correct position in relation to a reference tooth of the gear.

For bevel gears, the pitch deviations are defined in the ISO 17485:2006 standard. For cylindrical gears, the pitch deviations are defined in the standard DIN ISO 1328-1:2018-03. When referring to pitch deviations in this text, the definitions of the aforementioned standards are applied in particular.

In order to maintain the predefined tolerances for the permissible pitch deviations for bevel gears, it is known to perform a so-called pitch compensation in order to compensate for the pitch deviations due to the thermal expansion of the gear during production.

In this case, for example, the respective depth position of the gear tool in relation to the gear to be produced is adjusted for each individual tooth gap of the gear. For example, if a gear has twenty tooth gaps, an individual correction of the respective depth position of the gear tool for pitch compensation can be specified for each individual tooth gap. In this example, the pitch compensation therefore comprises twenty correction parameters—one for each tooth gap.

Furthermore, a rotational position of the gear in relation to the gear tool can be adjusted for each tooth gap. With reference to the example mentioned above, the pitch compensation can therefore have twenty further correction parameters for the rotational position of the gear in relation to gear tool—again individually for each tooth gap to be produced. The correction values for a depth position and/or rotational position deviating from the actual nominal data therefore serve as compensation parameters for pitch compensation.

Alternatively, an individual parameter set can be predefined for each tooth gap, wherein each parameter set can contain a plurality of parameters. The pitch compensation for the above example therefore comprises twenty parameter sets—one parameter set for each tooth gap.

The European patent specification EP 1 981 674 B1 describes such a pitch compensation for bevel gears, which are manufactured in the single-indexing method. From the European patent specification EP 1 981 674 B1 it is known to compensate pitch deviations for each tooth of a bevel gear individually by determining the pitch errors for a reference workpiece for each tooth or for each tooth gap and by correction on this basis. Compared to linear pitch compensation, i.e. compensation averaged over all teeth, this procedure avoids correcting teeth that have no pitch errors or for which linear compensation would lead to an increase in the pitch error.

It has been shown that in the series production of bevel gears, despite a predefined pitch compensation, pitch deviations can occur that lie outside the required tolerance range. In operational practice, this can lead to compensation parameters of the predefined pitch compensation being manually adjusted by a machine operator in order to maintain the required tolerances for the pitch error. This can lead to longer downtimes of a machine tool and also to an increased proportion of bad parts.

### SUMMARY

Against this background, the present disclosure is based on the technical problem of specifying a method that enables reliable pitch compensation in series production. The technical problem described above is solved with the features of claim 1. Further embodiments of the disclosure result from the dependent claims and the following description.

According to a first aspect, the disclosure relates to a method for manufacturing gears, comprising the method steps: machining of a plurality of gears with a gear tool in a single-indexing method, wherein the gear tool produces a plurality of tooth gaps on each gear of the plurality of gears by machining, and wherein pitch compensation with compensation parameters is predefined for the plurality of gears. The method is characterized in that the compensation parameters are predefined by a machine control system as a function of a wear condition of the gear tool.

The disclosure is based on the knowledge that the pitch deviations to be compensated change with increasing gear tool wear of the gear tool.

If, for example, three hundred gears are to be cut with the gear tool before the gear tool is resharpened or reconditioned, unacceptable pitch deviations may occur, for example, from the hundredth or two hundredth gear produced. Tests by the applicant have shown that as gear tool wear increases, i.e. as the gear tool cutting edges become “duller”, the heat input into the manufactured gears also increases. This results in increasing thermal expansion of the gears during machining, so that the pitch deviations to be compensated also change.

Insofar as a gear tool is in the new or newly reconditioned state, the machine control system therefore selects different compensation parameters than would be the case for a gear tool whose cutting edges have already been used. For example, a gear tool can still be considered “new” for a given number of machined gears, so that compensation parameters can be used for the new state, while other compensation parameters are used after this number has been exceeded.

The fact that, according to the disclosure, gear tool wear is now taken into account when setting the compensation parameters means that reliable compensation of the pitch error can be achieved in series production. Manual intervention by a machine operator is no longer necessary or can be avoided.

In particular, it may be provided that the compensation parameters are automatically preset by the machine control system as a function of a wear condition of the gear tool. If the wear condition of the gear tool monitored by the machine control system changes, for example, in such a way that a pitch deviation outside a predefined tolerance range is to be expected for gears to be subsequently produced, the compensation parameters can be automatically adjusted by the machine control system in order to avoid rejects.

In particular, it may be provided that the compensation parameters for a predetermined batch size of the plurality of gears are adjusted at least once, in particular at least twice, and further in particular at least three times, in particular adjusted at most once for each gear of the predetermined batch size of the plurality of gears.

It may be provided, for example, that the batch size of the plurality of gears is up to 500 pieces, in particular up to 400 pieces, further in particular up to 300 pieces. In particular, it may be provided that the predefined batch size is completely machined with a single gear tool before the gear tool is reconditioned or sharpened. The batch size therefore corresponds in particular to the predefined number of pieces of the plurality of gears to be machined with a gear tool without reconditioning the gear tool.

When reference is made to compensation parameters, these refer in particular to correction values for the infeed depth or depth position of the gear tool relative to the gear and/or correction values for the relative rotational position of the gear with respect to the gear tool. A correction value for the infeed depth or depth position and/or a correction value of the relative rotational position of the gear is specified for each tooth of the gear. The compensation parameters can contain individual correction values or parameters for each tooth gap or tooth, or comprise a parameter set. For each tooth gap, therefore, an individual parameter set can be specified in particular, which can contain a plurality of correction values or parameters.

The correction values can be determined by a linear, averaged correction or individually for each tooth. For a gear with ten teeth, the compensation parameters therefore include, for example, twenty correction values insofar as a correction value for the infeed depth or depth position of the gear tool relative to the gear and a correction value for the relative rotational position of the gear with respect to the gear tool is specified for each tooth.

Alternatively, the compensation parameters can have a parameter set for each tooth or tooth gap, wherein each parameter set can contain a plurality of correction values or parameters. For each tooth, for example, these can be adapted settings for one, two or more axes of a CNC-controlled machine tool or gear cutting machine with which the gear is manufactured.

Wherein reference is made in the present case to modified compensation parameters or second compensation parameters, it may concern, for example, an adjustment of existing compensation parameters. Insofar as first compensation parameters for a third tooth gap, for example, provide for a correction of the depth position by 10 micrometers, this correction of the depth position can be increased by 5%, for example, to account for the increased gear tool wear. Similarly, all other compensation values can be increased by 5% to account for the increased gear tool wear.

It may be provided that second compensation parameters are automatically calculated by a machine control system from first compensation parameters by storing a conversion formula in the machine control system to convert first compensation parameters into second compensation parameters.

It is understood that for a particular tooth or a plurality of teeth of a gear, one of the correction values may be zero, or both correction values may be zero, so that no compensation is required for one or more teeth, or only one non-zero correction value is predefined.

The correction values represent deviations from process data generated during the design of the gear on the basis of the theoretical nominal geometry of the toothing. For example, in the theoretical process design, the same infeed depth or depth position of the gear tool relative to the gear is initially specified for each tooth gap, since no thermal effects are taken into account here. Similarly, the same increment is initially specified for each tooth gap for a workpiece spindle rotation that takes place after a tooth gap has been produced, which corresponds to a workpiece rotation about its own axis corresponding to the amount of the nominal pitch. The correction values adjust this process data for each tooth or tooth gap to account for the heat input by the gear tool.

If reference is made above to reconditioning or sharpening a gear tool, this can mean that cutting inserts of a gear cutting tool are replaced and/or ground and, if necessary, recoated. For example, it may be provided that the gear tool has a plurality of replaceable bar knives whose cutting edges and rake faces are worn by chipping or abrasion during chip removal. These bar knives can be ground in a grinding machine in order to produce defined cutting edges and rake faces on the bar knives again. For example, it may be provided that the cutting edges are provided with a defined cutting edge rounding to increase gear tool life. It is also possible to provide or renew a CVD or PVD coating on the bar blades in order to increase the gear tool life.

The gear tool can be a bar cutter head for gear cutting, wherein the bar cutter head can have a base body with cutter receptacle openings and wherein bar cutters are detachably held in the cutter receptacle openings.

In order to take gear tool wear into account during the production of larger quantities, it may be provided that first compensation parameters for pitch compensation are predefined for a first wear condition of the gear tool, that second compensation parameters for pitch compensation are predefined for a second wear condition of the gear tool, that the gear tool has less gear tool wear in the first wear condition than in the second wear condition, and that the first compensation parameters are different from the second compensation parameters. With the aid of the machine control system, the compensation parameters can therefore be adapted to the gear tool wear. In this way, reliable compliance with predefined pitch tolerances can be ensured even with increasing gear tool wear, without the need for user intervention.

Therefore, it may be provided that pitch compensation is performed for a first subset of the plurality of gears with the first compensation parameters and that pitch compensation is performed for a second subset of the plurality of gears with the second compensation parameters.

According to further designs of the method, it may be provided that third, fourth or n-th compensation parameters for pitch compensation are predefined for a third, fourth or n-th wear condition of the gear tool, where “n” corresponds at most to a predefined number of pieces or batch size of the plurality of gears.

It may thus be provided that the pitch compensation for a third subset of the plurality of gears is performed with the third compensation parameters, that the pitch compensation for a fourth subset of the plurality of gears is performed with the fourth compensation parameters, and that the pitch compensation for an n-th subset of the plurality of gears is performed with the n-th compensation parameters. Therefore, in the case where “n” corresponds to the number of pieces or batch size of the plurality of gears, adjusted compensation parameters are predefined for each gear.

The gears to be manufactured may be bevel gears. In particular, it may be provided that each of the plurality of gears is a bevel gear, especially a ring gear.

Gear tool wear can be measured or estimated by means of test series.

When referring to the consideration of gear tool wear in this case, the gear tool wear is not directly determined or measured, but preferably indirectly considered by monitoring measured values or process variables that influence the gear tool wear or are influenced by the gear tool wear.

For example, the number of gears cut with a gear tool influences the wear of the gear tool. It can therefore be assumed that a gear tool with which ten gears have been cut has less wear than the same gear tool with which one hundred of these gears have already been cut. The wear condition can therefore be measured or determined, for example, in the unit “number of cut gears”. Similarly, gear tool wear could be measured in the units “number of tooth gaps machined,” “machined volume,” or “machined distance”.

For example, a current and/or power consumption of a tool spindle drive is influenced by the wear of the gear tool, since the chip forming energy and forming energy required for chip removal increases with increasing wear of the gear tool. The increasing wear of the gear tool therefore leads to a measurable increase in the current and/or power consumption of a tool spindle drive, so that the wear of the gear tool can be measured in the units “change in current consumption” or “change in power consumption” of the tool spindle drive.

It can therefore be provided that the number of gears machined with the gear tool is determined, wherein the number of gears machined with the gear tool represents the wear condition of the gear tool. In other words, the wear condition of the gear tool is determined or measured in the unit “number of gears toothed with the gear tool”.

If, for example, it is known that a gear tool usually produces gears whose pitch deviations lie outside a predefined tolerance after more than one third and again after more than two thirds of the expected service life, the compensation parameters can be adjusted accordingly. For example, if a service life of 300 gears is assigned to a gear tool, the compensation parameters can be automatically adjusted by the machine control system once after the hundredth gear produced and again after the two hundredth gear produced. The number of gears produced with a gear tool therefore indirectly permits a conclusion or an estimate of the wear condition of the gear tool.

Alternatively or additionally, it may be provided that a current consumption and/or a power consumption of a tool spindle drive with which the gear tool is rotationally driven is measured, wherein a change in the current consumption and/or power consumption represents the wear condition of the gear tool. In other words, the wear condition of the gear tool is determined or measured in the unit “change in current consumption and/or power consumption of the tool spindle drive”.

As already mentioned above, the current consumption or power consumption of the tool spindle drive used to rotationally drive the gear tool allows a conclusion to be drawn about the wear condition of the gear tool in that the current consumption or power consumption of the tool spindle drive increases with increasing gear tool wear. This is because the more worn the gear tool is, or the “duller” the gear tool is, the more energy the tool spindle drive has to expend for chip removal with the gear tool in order to produce the teeth of the gear.

Accordingly, current and/or power consumption can be measured to detect the wear condition or various gradations of gear tool wear, with each wear level having its own set of compensation parameters associated with it.

For example, it may be provided that a curve of the current and/or power consumption for a new state of the gear tool is known or measured in the new state of the gear tool for the production of a tooth gap. For example, the work carried out to produce a gap can be determined as an integral of the power curve over the machining time. As far as the work required to produce a gap increases, for example, by more than 10% or by more than 20%, the compensation parameters are adjusted. Such a procedure can equally be carried out for the current consumption.

Alternatively or additionally, it may be provided that the compensation parameters are adjusted by the machine control system as soon as a mean or averaged current and/or power consumption of the tool spindle drive exceeds a predefined setpoint value for the mean current and/or power consumption by more than 10%, in particular by more than 20%, during the production of a gear. If an average power consumption of 30 kW is predefined as the setpoint during the production of a bevel gear, the compensation parameters are adjusted by the machine control system as soon as the measured average power consumption exceeds 33 kW (10%) or 36 kW (20%).

Alternatively or additionally, it may be provided that the wear condition of the gear tool is concluded on the basis of at least one of the operating parameters or characteristic values listed in the following: Vibration or noise excitation by a cutting contact of the gear tool, temperature of a gear to be cut, discoloration of the lifted chips, shape of the lifted chips.

Accordingly, the operating parameters or characteristics can be measured in order to estimate the wear condition or various gradations of gear tool wear, wherein a separate data set of compensation parameters can be assigned to each wear level or a separate data set of compensation parameters can be calculated within the machine control system for each wear level.

For example, with increasing gear tool wear, the vibration or noise excitation caused by the cutting contact of the gear tool can increase. These can be detected, for example, with structure-borne sound sensors, microphones or the like.

The temperature of the respective toothed gear can be measured after or during machining in order to record the wear condition of the gear tool.

The shape and color of the chips lifted off also allows conclusions to be drawn about the cutting process, since the color of the chips in particular can indicate the temperatures occurring during chip removal in the cutting contact.

Alternatively or additionally, according to a further design of the method, a pitch deviation of at least one gear of the plurality of gears can be determined, in that the at least one gear on which the pitch deviation is measured is in particular one of the last five manufactured gears of a subset of the plurality of gears, and in that the subset of the plurality of gears comprises in particular twenty gears or more, wherein the pitch deviation represents the wear condition of the gear tool. In other words, the wear condition of the gear tool is determined or measured in the “pitch deviation change” unit. On this basis, new compensation parameters can be calculated or existing compensation parameters can be converted by the machine control system.

According to a further embodiment of the method, it may be provided that the pitch measurement is carried out within a machine tool with which the machining of the plurality of gears with the gear tool is carried out. In this way, the conclusion about the wear condition of the gear tool can be drawn directly within the machine tool that also performs the machining of the gears. In this way, the wear condition of the gear tool can be efficiently detected and the compensation parameters can be adjusted within the machine tool.

The pitch measurement or the measurement of the pitch deviation can be carried out with the aid of tactile measuring methods. For example, a measuring probe can probe all right and/or left flanks individually to determine the pitch deviations. Tactile pitch measurement is robust and less error-prone than optical measuring methods.

Alternatively or additionally, the pitch deviation can be measured optically. The pitch measurement by means of optical measurement takes only a few seconds.

The pitch measurement can be carried out in one chucking, in which both the gear tooth cutting of the gear to be measured with the gear tool and the measurement of the gear are carried out while the gear is clamped on a workpiece spindle of the machine tool and the gear is not released from the workpiece spindle after the gear cutting and before the measurement. This enables rapid detection of pitch deviations.

It may be provided that the measurement of pitch deviations is performed on every twentieth, every tenth, every fifth, every fourth, every third, every second or on every single gear in order to detect the progression of the pitch deviation with increasing gear tool wear and subsequently adjust the pitch compensation if the pitch deviations become too large and threaten the production of rejects.

Alternatively or additionally, it may be provided that the wear condition of the gear tool can be determined by measuring wear on the cutting edges of the gear tool. For example, the dimensions of chipping or abrasion on cutting edges and/or rake faces of the gear tool can be recorded. In particular, the wear measurement on cutting edges and/or rake faces of the gear tool can be performed optically.

Presetting the compensation parameters may comprise the following method step: Reading out stored compensation parameters from a data memory of the machine control system. Various data sets of compensation parameters can be stored in the data memory for a gear tool, with each data set being assigned a wear condition of the gear tool.

For example, the compensation parameters may have been determined using measurements and/or simulations.

It may be provided that for the determination of compensation parameters an interpolation between stored compensation parameters takes place, which are stored in the data memory of the machine control system.

It may be provided that similar compensation strategies are used for similar gear-tooth gear tool pairings. For example, if the wear behavior of a gear tool for a gear made of a certain material is known, this can be used to draw conclusions about the wear behavior of a similar gear tool that is also to be used to machine a gear made of this material.

### BRIEF DESCRIPTION OF THE DRAWINGS

The disclosure is explained in more detail below by means of a drawing illustrating an exemplary embodiment, wherein the drawings each show schematically:

FIG. 1 shows a gear in transverse section with measuring devices for pitch measurement;

FIG. 2 shows a measurement result of a pitch deviation with and without pitch compensation;

FIG. 3A shows a ring gear in perspective view from above;

FIG. 3B shows a detail enlargement of the ring gear from FIG. 3B;

FIG. 4 shows a machine tool for gear machining;

FIG. 5 shows a gear tool and a ring gear;

FIG. 6 shows a bar blade and a tooth gap;

FIG. 7A shows a bar blade in new condition;

FIG. 7B shows the bar blade from FIG. 7A in a wear condition; and

FIG. 8 shows a flow diagram of a method according to the disclosure.

### DETAILED DESCRIPTION OF THE DRAWINGS

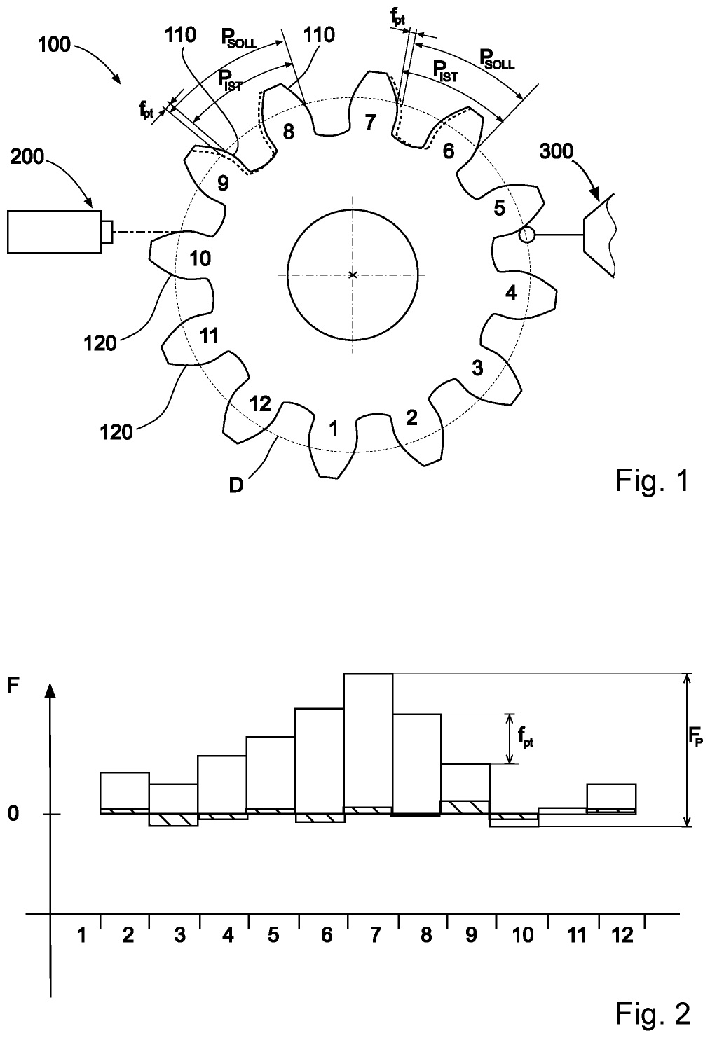

FIG. 1 shows a gear 100 whose teeth are numbered 1-12. The geometry of the gear 100 is measured using an optical measuring system 200 and a tactile measuring system 300. The measurement of individual pitch deviations fₚₜ for the right flanks 110 of the gear 100 is shown as an example.

A nominal pitch P_{SOLL} is the theoretically predefined distance between two adjacent right flanks 110 or two adjacent left flanks 120 at the level of a diameter D. The individual pitch deviation fₚₜ is calculated for each tooth as the difference between the actually measured pitch P9_{IST} minus the nominal pitch P_{SOLL}.

The individual pitch deviations fₚₜ are positive for tooth 6, since the measured pitch P_{IST} is larger than the nominal pitch P_{SOLL}. The individual pitch deviations fₚₜ are negative for tooth 8 because the measured pitch P_{IST} is smaller than the nominal pitch P_{SOLL}. The theoretical flank to be generated is indicated by a dashed line in each case. It is understood that these are highly schematic representations to illustrate the deviations occurring in the micrometer range.

FIG. 2 shows an example of a result of such a pitch measurement for the right flanks. The total pitch error F illustrates a total pitch deviation F_{P} and also shows the individual pitch deviations fₚₜ from tooth to tooth. In the diagram, the individual pitch deviations fₚₜ are added up one after the other according to the numbering of the teeth. The total deviation F for tooth 7 therefore represents the sum of all individual pitch deviations fₚₜ up to tooth 7 in the diagram.

The shaded bars in FIG. 2 show exemplary pitch deviations after pitch compensation has been performed for the gear 100. The pitch deviations could therefore be significantly reduced by the pitch compensation.

In the following, the method according to the disclosure is described with reference to the manufacture of ring gears 400 for a toothed gearing of a bevel gear. If reference is made here to a toothed gearing of a bevel gear, it is a pairing of a pinion and an associated ring gear, which are set up to convert speeds and torques between crossing or skew axes by rolling the teeth in mutual mesh.

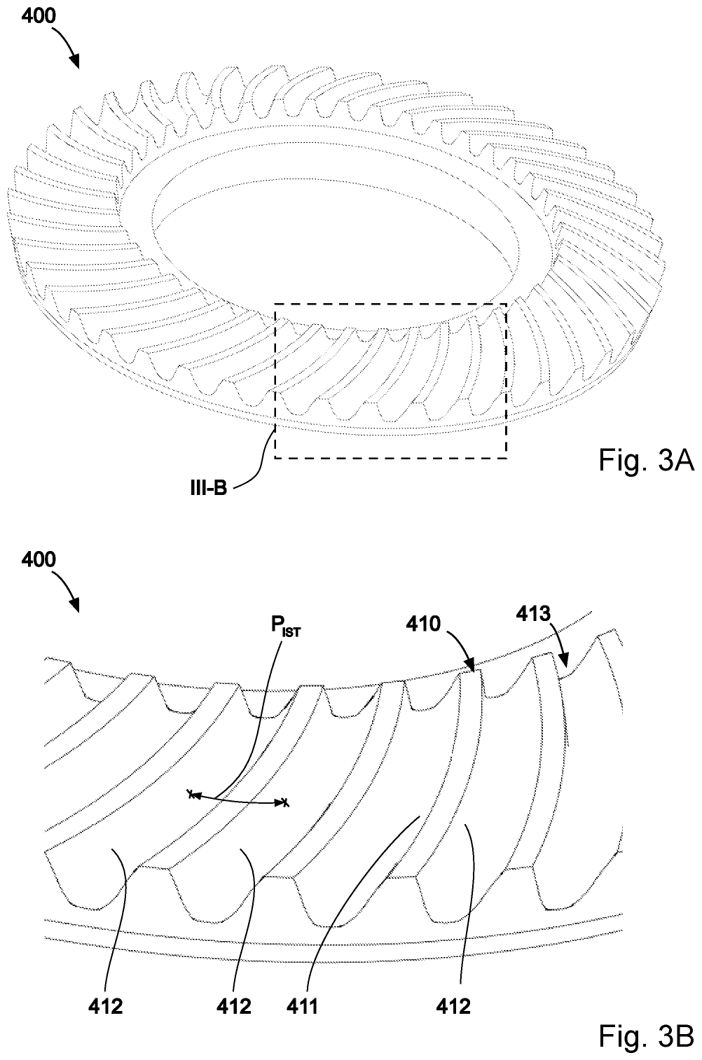

FIG. 3A shows an exemplary perspective view of a ring gear 400 from above. FIG. 3B shows a detail enlargement of the ring gear 400, with the enlarged detail in FIG. 3A labeled III-B.

The ring gear 400 has teeth 410, wherein each tooth 410 has a concave flank 411 and a convex flank 412, and tooth gaps 413 are formed between the teeth 410. In the enlarged view shown in FIG. 2B, an actual pitch P_{IST} is shown as an example for two adjacent convex flanks 412.

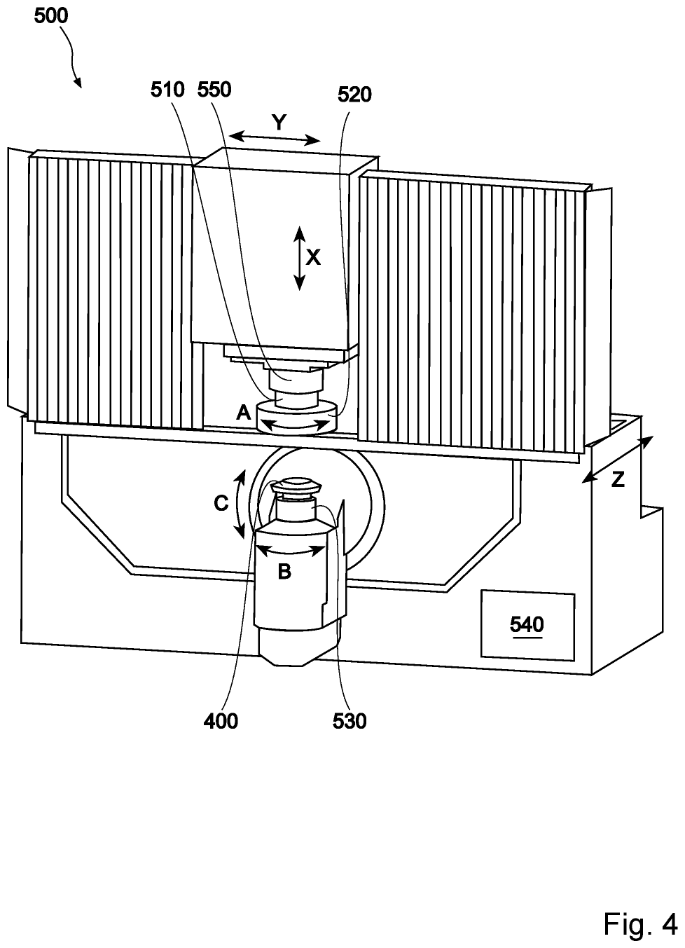

FIG. 4 shows a machine tool 500 for manufacturing bevel gears, such as a ring gear 400 shown in FIG. 3A. The machine tool 500 has a tool spindle 510 for accommodating a bar cutter head 520. The bar cutter head 520 is a gear cutting tool 520 and is arranged for individually cutting the teeth 410 of a respective ring gear 400. The machine tool 500 has a machine control system 540. A tool spindle drive 550 is used to rotate the gear tool 520 about its own axis.

The ring gear 400 to be machined is held on a workpiece spindle 530 of the machine tool 500.

Relative motion or infeed motion of the cutter head 520 relative to the ring gear 400 is effected by three linear axes X, Y, and Z, a pivot axis C, and a workpiece rotation axis B. The pivot axis C essentially causes the workpiece spindle 530 to rotate or pivot about the Z axis. The

B axis causes the ring gear 400 to rotate about its own axis L. The tool spindle drive 550 for generating the gear tool rotation or cutting speed causes rotation about the X axis, wherein this rotation is denoted A.

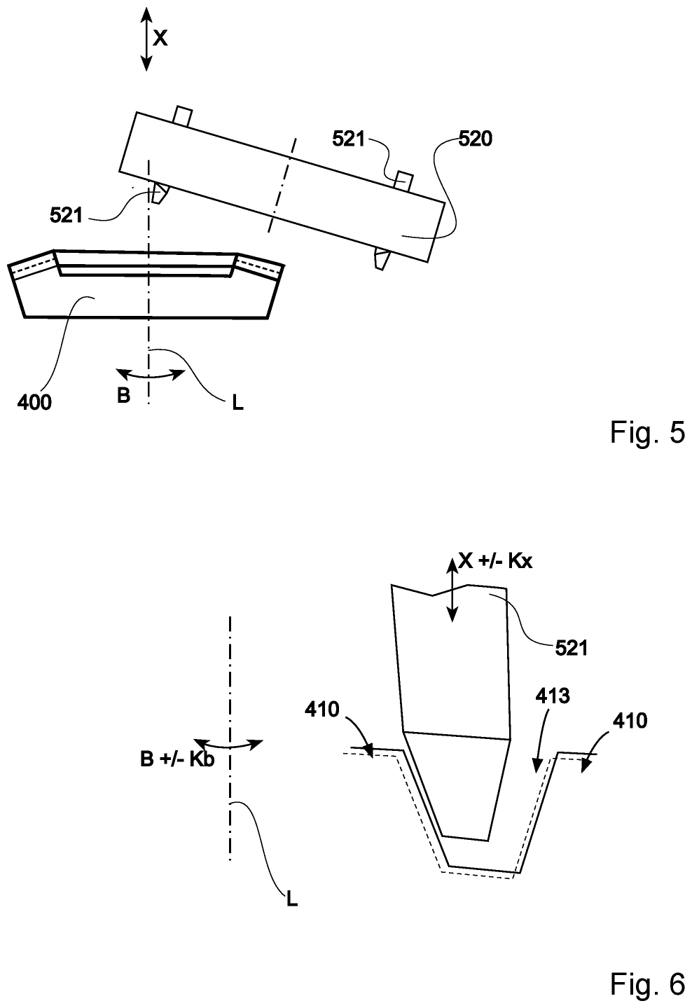

FIG. 5 shows an example of the ring gear 400 with the cutter head 520. The cutter head 520 has a plurality of bar blades 521 that are arranged to produce the concave and convex flanks 411, 412.

According to the disclosure, a method for producing gears 400 is specified, comprising the method steps: gear cutting of a plurality of gears 400 with the gear cutting tool 520 in the single-indexing method, wherein the gear cutting tool 520 produces a plurality of tooth gaps 413 on each gear 400 of the plurality of gears 400 by machining, and wherein a pitch compensation with compensation parameters is predefined for the plurality of gears 400. The compensation parameters are predetermined by the machine control system 540 of the machine tool 500 depending on a wear condition of the gear cutting tool 520.

For example, for each tooth 410 or for each tooth gap 413, a theoretical depth position of the gear cutting tool 520 in the X direction is corrected by a value Kx and a theoretical rotational position of the ring gear 400 is corrected by a value Kb, as exemplified in FIG. 6. Here, the dashed line in FIG. 6 shows the uncompensated position of the gap while the solid line shows the compensated position of the gap.

The machine control system 540 takes into account the wear condition of the gear cutting tool 520.

It may be provided that first compensation parameters for pitch compensation are predetermined for a first wear condition of the gear tool 520, that second compensation parameters for pitch compensation are predetermined for a second wear condition of the gear tool 520, that the gear tool 520 has a lower tool wear in the first wear condition than in the second wear condition, and that the first compensation parameters are different from the second compensation parameters.

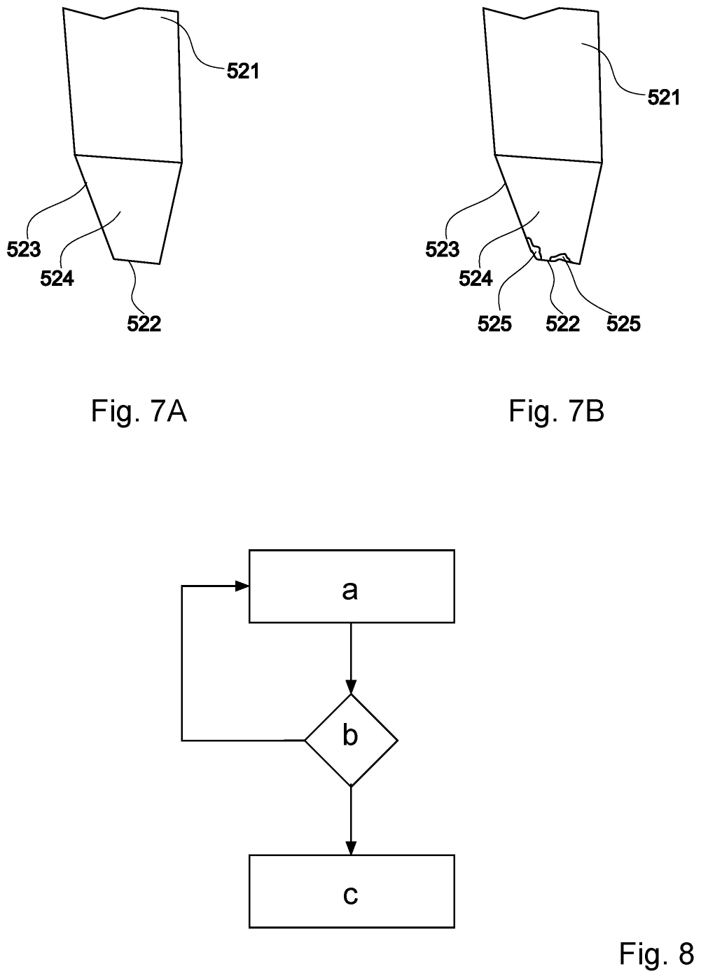

FIG. 7A shows a bar blade 521 of the gear cutting tool 520 in a new condition. The new condition according to FIG. 7A corresponds to the aforementioned first wear condition. FIG. 7B shows a bar blade 521 of the gear cutting tool 520 in a partially worn condition after manufacturing some ring gears 400. The partially worn condition according to FIG. 7B corresponds to the aforementioned second wear condition.

In FIG. 7B, it is shown by way of example that breakouts 525 are formed in the region of a top cutting edge 522, a main cutting edge 523 and a rake face 524 of the bar blade. These breakouts 525 increase the friction and the forming work during chip removal.

Therefore, insofar as the bar blades 521 of the gear tool 520 are in the partially worn condition, the heat input increases during manufacturing of a ring gear 400 compared to manufacturing with the gear cutting tool 520 in the new condition. Accordingly, the expansion of the material of the ring gear 400 also increases during manufacturing, so that pitch compensation with the first compensation parameters, which enables reliable adherence to predefined tolerances for the new condition of the gear tool 520, is no longer effective for the worn condition of the gear tool 520. Therefore, for the worn condition of the gear cutting tool 520, a pitch compensation with second compensation parameters that differs from the new state is predefined by the machine control system 540.

According to the present embodiment of the disclosure, it is accordingly provided that the pitch compensation for a first subset of the plurality of gears 400 is performed with the first compensation parameters and that the pitch compensation for a second subset of the plurality of gears 400 is performed with the second compensation parameters.

In this case, the plurality of gears 400 may have a predetermined number of pieces that are intended to be manufactured with the gear cutting tool 520 before the gear cutting tool is reconditioned. For example, it may be provided that a quantity of three hundred gears 400 is manufactured with the gear cutting tool 520 before the gear cutting tool 520 is reconditioned. In this regard, the first subset for which pitch compensation is performed with first compensation parameters may be two hundred pieces, for example, such that the second subset for which pitch compensation is performed with second compensation parameters is one hundred pieces.

In order to select the suitable compensation parameters, the wear condition of the gear tool 520 is determined. In particular, influencing variables or parameters are taken into account that allow indirect conclusions to be drawn about the wear condition of the gear tool.

According to a first variant of the method according to the disclosure, it is provided that the wear condition of the gear tool 520 is inferred on the basis of the number of gears 400 toothed with the gear tool 520. For example, insofar as it is known for the gears 400 that the pitch compensation no longer permits the required tolerances from a number of pieces of approximately two hundred gears 400 manufactured, the machine control system 540 can automatically use second compensation parameters instead of the first compensation parameters from the two hundredth or one hundred and eightieth component manufactured, which take into account the expected gear tool wear. Accordingly, compensation parameters for the various wear conditions of the gear tool 520 may be stored in a database of the machine control system.

Accordingly, the sequence of the first method variant is as follows according to FIG. 8: In step a, a gear 400 with first compensation parameters is manufactured. In step b, it is checked whether the number of manufactured gears is less than or equal to, for example, 180. If the check in step b shows that the number of gears manufactured is less than or equal to 180, a gear 400 with first compensation parameters is manufactured again. If the check in step b shows that the number of gears manufactured is greater than 180, a subsequent gear 400 and the further subsequent gears 400 are manufactured with second compensation parameters according to step c.

According to a second variant of the method according to the disclosure, it is provided that the wear condition of the gear tool 520 is inferred on the basis of a current and/or power consumption of the tool spindle drive 550 of the tool spindle 510, with which the gear tool 520 is rotationally driven.

In the present case, the current and/or power consumption of the tool spindle drive 550 of the tool spindle 510, which is used to rotationally drive the gear tool 520, is continuously recorded during the production of the gears 400 and evaluated by means of the machine control system 540. To the extent that it is determined within the machine control system 540 that an average power consumption during the cutting of a gear 400 has increased by more than more than 20% compared to previously manufactured gears or a predetermined target value, an adjustment of the compensation parameters for subsequent components may be made by the machine control system 540. This is because the increased power consumption indicates dulling or wear of the gear tool 520.

According to FIG. 8, the sequence of the second method variant is, for example, as follows: In a step a, a gear 400 is manufactured with first compensation parameters. Subsequently, in a step b, it is checked whether the average current and/or power consumption of the tool spindle drive 550 of the tool spindle 510 has increased by more than 20% compared to a predetermined set value. If the average current and/or power consumption of the tool spindle drive 550 of the tool spindle 510 has not increased or has increased by less than 20% compared to the predetermined setpoint, another gear 400 is manufactured using the first compensation parameters. If the average current and/or power consumption of the tool spindle drive 550 of the tool spindle 510 has increased by more than 20% compared to the predetermined setpoint, a subsequent gear 400 and further subsequent gears 400 are manufactured with the second compensation parameters according to step c.

According to a third variant of the method according to the disclosure, it is provided that the wear condition of the gear tool 520 is concluded on the basis of a measurement of a pitch deviation of at least one gear 400 of the plurality of gears 400, that the at least one gear 400 at which the pitch deviation is measured is in particular one of the five most recently manufactured gears of a subset of the plurality of gears 400, and that the subset of the plurality of gears comprises in particular 20 gears or more. In this way, it is possible to check at predetermined intervals to what extent the currently used compensation parameters allow effective compensation of the pitch deviations, or whether the gear tool wear has already progressed to such an extent that the machine control system 540 must make an adjustment to the compensation parameters in order to reliably maintain the predetermined tolerances.

Here, the pitch measurement is performed within the machine tool or gear cutting machine 500. The pitch measurement is therefore performed in one setup, in which both the gear cutting of the gear 400 of the plurality of gears 400 with the gear tool 520 and the measurement of the gear 400 are performed while the gear 400 is clamped to the workpiece spindle 530 of the machine tool 500 and the gear 400 is not released from the workpiece spindle 530 after the gear cutting and before the measurement. The measurement of the pitch deviation is performed mainly in a tactile manner.

According to FIG. 8, the sequence of the third method variant is, for example, as follows: In a step a, a gear 400 is manufactured with first compensation parameters. Then, in a step b, it is checked whether the pitch deviation of the gear 400 to be measured is within the predefined tolerances. If the pitch deviation is within the tolerance, further gears 400 are manufactured with first compensation parameters until a new measurement of a further gear is performed in step b. If the pitch deviation then lies outside the tolerance, the subsequent further gears 400 are manufactured with the second compensation parameters according to step c.

According to a fourth variant of the method according to the disclosure, the wear condition of the gear cutting tool 520 is determined by a wear measurement on cutting edges 521, 522, 523 of the gear cutting gear tool 520. The wear measurement can be carried out optically.

According to FIG. 8, the sequence of the fourth method variant is, for example, as follows:

In a step a, a gear 400 is manufactured with first compensation parameters. Subsequently, in a step b, it is checked whether the gear tool wear of the gear tool 520 is within the predefined tolerances. If the gear tool wear is within the tolerance, further gears 400 are manufactured with first compensation parameters until a new measurement of the gear tool wear in step b is performed. If the gear tool wear is then outside the tolerance, the subsequent further gears 400 are manufactured with the second compensation parameters in accordance with step c.

In this case, the compensation parameters are predefined by reading out stored compensation parameters from a data memory of the machine control system.

The method variants described above can be combined with each other.

From step c, gear tool wear can continue to be monitored analogously to FIG. 8 in order to use third or fourth compensation parameters if necessary.

1. A method for manufacturing gears, the method including the following steps:
machining of a plurality of gears with a gear tool in a single-indexing method,
wherein the gear tool produces a plurality of tooth gaps on each gear of the plurality of gears by chip removing machining, and
wherein a pitch compensation with compensation parameters is predefined for the plurality of gears;
wherein
the compensation parameters are preset by a machine control system depending on a wear condition of the gear tool.

2. The method according to claim 1, wherein
first compensation parameters for the pitch compensation are predefined for a first wear condition of the gear tool,
second compensation parameters for the pitch compensation are predefined for a second wear condition of the gear tool,
the gear tool has a lower gear tool wear in the first wear condition than in the second wear condition, and
the first compensation parameters are different from the second compensation parameters.

3. The method according to claim 2, wherein
the pitch compensation for a first subset of the plurality of gears is performed using the first compensation parameters, and
the pitch compensation is performed for a second subset of the plurality of gears with the second compensation parameters.

4. The method according to claim 2, wherein
the second compensation parameters are calculated automatically by the machine control system from the first compensation parameters,
wherein a conversion formula is stored in the machine control system to convert first compensation parameters into second compensation parameters.

5. The method according to claim 1, wherein
the number of gears machined with the gear tool is determined,
wherein the number of gears machined with the gear tool represents the wear condition of the gear tool.

6. The method according to claim 1, wherein
a current consumption and/or a power consumption of a tool spindle drive with which the gear tool is rotationally driven is measured,
wherein a change in current consumption and/or power consumption represents the wear condition of the gear tool.

7. The method according to claim 1, wherein
a pitch deviation of at least one gear of the plurality of gears is determined,
the at least one gear on which the pitch deviation is measured is in particular one of the last five manufactured gears of a subset of the plurality of gears, and
the subset of the plurality of gears comprises in particular twenty gears or more,
wherein the pitch deviation represents the wear condition of the gear tool.

8. The method according to claim 7, wherein
the pitch measurement is carried out within a machine tool with which the machining of the plurality of gears with the gear tool is also carried out.

9. The method according to claim 7, wherein
the pitch measurement takes place in one chucking,
in which both the machining of the gear to be measured with the gear tool and the measuring of the gear to be measured take place while the gear to be measured is chucked on a workpiece spindle of the machine tool, and
the gear to be measured is not disengaged from the workpiece spindle after gear cutting and before measuring.

10. The method according to claim 1, wherein
the wear condition of the gear tool is determined by a wear measurement on cutting edges of the gear tool.

11. The method according to claim 1, wherein
the presetting of the compensation parameters includes the following method step:
reading out stored compensation parameters from a data memory of the machine control.
